(19) United States
(12) Patent Application Publication
(10) Pub. No.: US 2024/0006679 A1
(43) Pub. Date: Jan. 4, 2024

(54) COOLING SYSTEM

(71) Applicant: RENAULT S.A.S, Boulogne Billancourt (FR)

(72) Inventors: Philippe RECOUVREUR, Guyancourt (FR); Christophe ROBIN, Guyancourt (FR)

(73) Assignee: RENAULT S.A.S, Boulogne Billancourt (FR)

(21) Appl. No.: 18/248,117

(22) PCT Filed: Oct. 5, 2021
(86) PCT No.: PCT/EP2021/077472

§ 371 Date: Apr. 6, 2023

(30) Foreign Application Priority Data
Oct. 7, 2020 (FR) 20 10262

(51) Int. Cl. H01M 10/625; H01M 10/613; B60L 58/26; H01M 10/617

(52) U.S. Cl. CPC H01M 10/625; H01M 10/613; H01M 2220/20; H01M 10/617; B60L 58/26

(57) ABSTRACT

A cooling system of a battery for an electric or hybrid vehicle includes a cooling device and a thermal interface. The cooling device generates a movement of a cooling fluid between an inlet point and an outlet point in a cooling direction. The thermal interface has a first surface at least substantially in contact with the cooling device and a second surface, referred to as the heat-exchange surface, opposite the first surface, intended to be placed in contact with or near a battery. The size of the heat-exchange surface in a secondary direction, perpendicular to the cooling direction of the cooling system, increases in the cooling direction.

The invention relates to a cooling system.

The performance of batteries in electric or hybrid vehicles is highly dependent on the operating temperature thereof. It is therefore necessary to control the temperature ranges to which such batteries are subjected.

For this purpose, most batteries in electric or hybrid vehicles are fitted with integrated cooling systems. These systems use a liquid or gas fluid flow to effect a thermal exchange between the fluid and the battery, via a thermal interface.

However, these cooling systems have the major disadvantage that the action of the system is not uniform, which results in a lack of temperature uniformity throughout the battery. This lack of uniformity makes it difficult to keep the battery within a given temperature range.

One way to control the thermal uniformity of a battery is to greatly increase the mass flow rate of the coolant fluid. However, this solution requires the use of large pumps and causes excessive power consumption.

U.S. Pat. No. 9,979,058 discloses the use of a thermal interface having increased thickness in certain areas to maximize the thermal exchange capacity between the cooling system and the battery. However, this solution has the drawback of increasing the volume of the battery, due to the extra thickness of the thermal interface.

The purpose of the invention is to provide a device and a method for the thermal management of vehicle batteries that overcomes the drawbacks mentioned above and improves the thermal management devices and methods known from the prior art. In particular, the invention provides a simple and reliable device and method that facilitate a uniform temperature distribution in a battery without increasing the volume of said battery.

The invention relates to a cooling system for a battery in an electric or hybrid vehicle, said cooling system comprising a cooling device and a thermal interface,
the cooling device generating a movement of a coolant fluid between an inlet point and an outlet point in a cooling direction, and
the thermal interface having a first surface that is at least substantially in contact with the cooling device and a second surface, referred to as the thermal exchange surface, opposite the first surface, intended to come into contact with or to be close to a battery, and
the dimension of said thermal-exchange surface in a secondary direction, perpendicular to the cooling direction of the cooling system, increasing in the cooling direction.

In one embodiment, the orthogonal projection of the thermal-exchange surface onto a plane parallel to the first surface is substantially in the shape of a funnel oriented along an axis parallel to the cooling direction.

In one embodiment, the contour of said funnel shape is defined by a mathematical law 1/X.

In one embodiment, the thermal interface is of constant thickness.

The invention also relates to an electrical power supply system for an electric or hybrid vehicle, comprising a battery and a cooling system according to the invention, the battery being in contact with or close to the exchange interface of the cooling system.

In one embodiment of the electrical power supply system,
the battery comprises several identical modules distributed in the secondary direction,
the thermal-exchange surface of the cooling system comprises a set of unitary surfaces having a longitudinal axis parallel to the cooling direction, at least one unitary surface being arranged between each module and the cooling device.

In one embodiment of the electrical power supply system,
each module has a longitudinal axis of symmetry parallel to the cooling direction, and comprises a set of cells arranged perpendicularly to the longitudinal axis of symmetry and distributed uniformly along the longitudinal axis of symmetry, and
within a given module, the contact area between a first cell and the at least one unitary surface is smaller than the contact area between a second cell, located further downstream than the first cell, and the at least one unitary surface.

In one embodiment of the electrical power supply system, all of the unitary surfaces of the thermal interface are identical.

The invention also relates to an electric or hybrid vehicle fitted with an electrical power supply system according to the invention.

The attached drawing shows an example embodiment of a cooling system according to the invention.

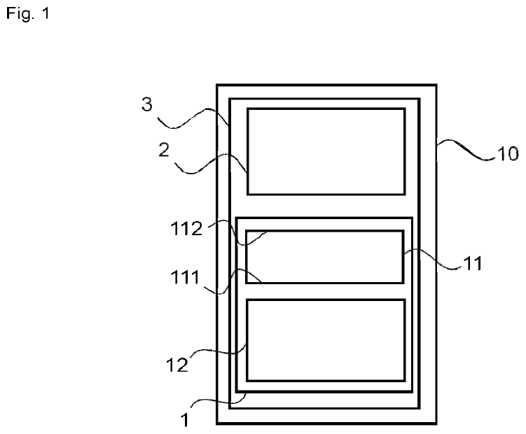

FIG. 1 is a schematic view of a motor vehicle fitted with a cooling system according to the invention.

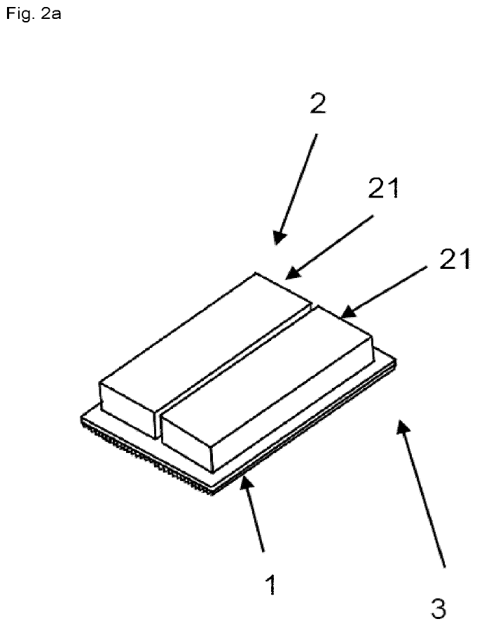

FIG. 2a is a perspective view of an embodiment of an electrical power supply system fitted with a cooling system.

FIG. 2b is a cross-sectional view of an embodiment of an electrical power supply system fitted with a cooling system.

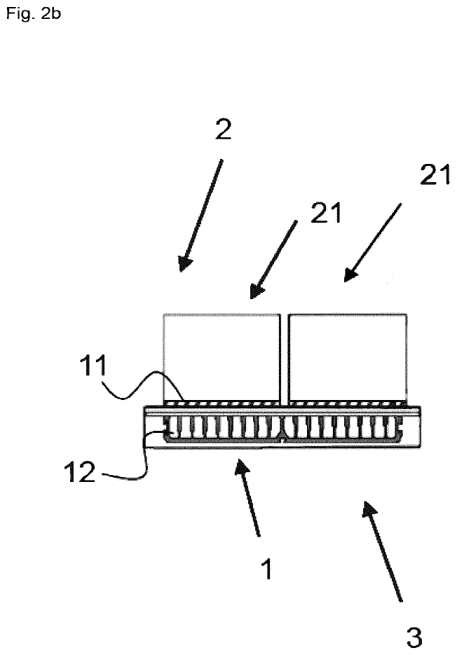

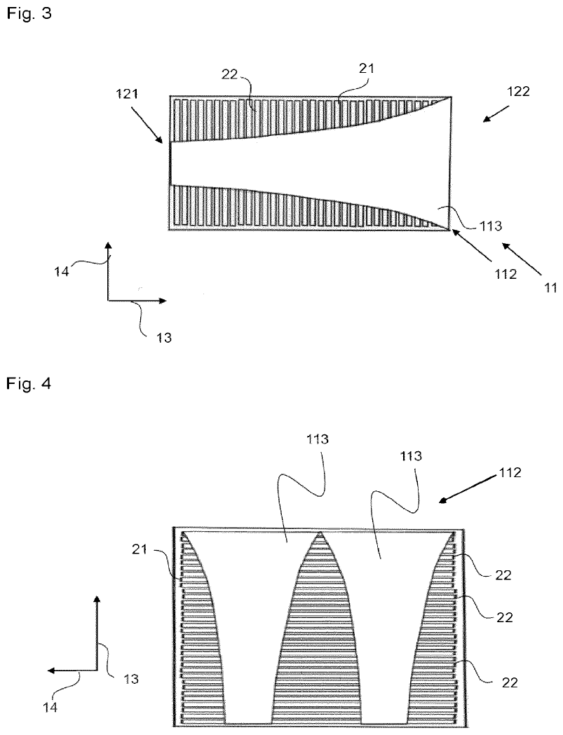

FIG. 3 shows a first embodiment of an electrical power supply system fitted with a cooling system according to the invention.

FIG. 4 shows a second embodiment of an electrical power supply system fitted with a cooling system according to the invention.

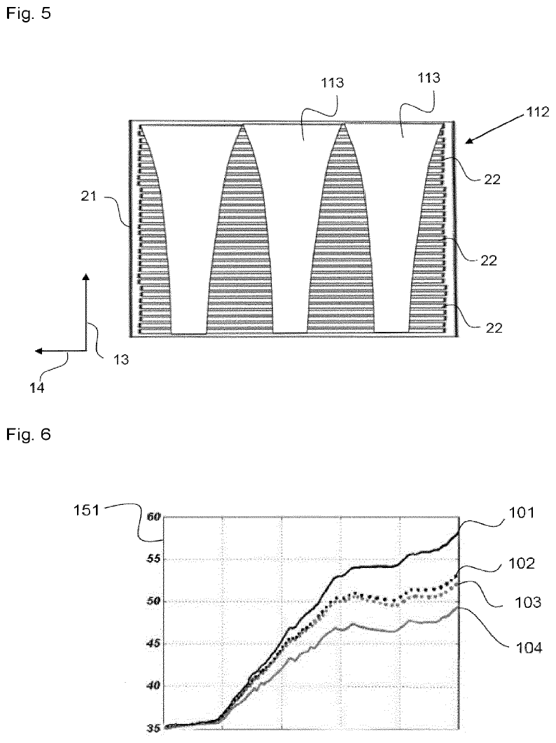

FIG. 5 shows a third embodiment of an electrical power supply system fitted with a cooling system according to the invention.

FIG. 6 compares the temporal evolution of the minimum and maximum temperatures of the cells of a battery fitted with a cooling system with and without implementation of the invention.

An example of an embodiment of a motor vehicle 10 fitted with a cooling system 1 according to the invention is described below with reference to FIG. 1.

The vehicle 10 is an electric or hybrid motor vehicle of any type, which may for example be a passenger car, a commercial vehicle, a truck, or a bus.

The vehicle 10 is fitted with an electrical power supply system 3.

The electrical power supply system 3 comprises an electric battery 2 and a cooling system 1.

The electric battery 2 can be an electric battery of any type. In particular, the electric battery can be a lithium battery using Li-ion technology.

Alternatively, the electric battery can be an all-solid lithium battery.

In one embodiment, the battery 2 comprises a set of modules 21, as shown in FIGS. 2a and 2b, each module comprising a plurality of battery cells 22 assembled in series or in parallel, as shown in FIGS. 4 to 6. The cells comprise an electrode assembly, for example using Li-ion or lithium-metal technology.

The vehicle 10 is fitted with a cooling system 1 according to the invention.

The cooling system 1 comprises a thermal interface 11 and a cooling device 12.

The cooling device 12 may include a structure implementing a circuit for moving a fluid between an inlet point 121 and an outlet point 122, as shown in FIG. 3.

In one minimal embodiment, the cooling device 12 may be passive, i.e. involving the substantially linear movement of ambient air between an inlet point and an outlet point of the cooling device, the movement of the air being generated by the movement of the vehicle carrying the cooling device. Advantageously, the direction of movement of the air corresponds to the longitudinal axis of the vehicle fitted with the cooling device.

Other embodiments of the cooling device 12 may be implemented, notably devices for moving liquids (such as water, glycol water, refrigerant, or dielectric fluids). These active devices require a circuit in the form of a pipe and a pump to move the liquid in the pipe.

Regardless of how the fluid is moved and regardless of the nature of the fluid, the implementation of the thermal exchange between the battery and the coolant fluid gradually heats the fluid as the fluid moves through the cooling device 12.

Any cooling device using a cooling circuit has a cooling direction 13, or main cooling direction 13.

In general, the cooling direction 13 can be defined as a straight line drawn from the inlet point of the fluid into the cooling circuit to the outlet point of the fluid from the cooling circuit. This direction represents the overall direction of movement of the fluid in the cooling device 12.

In the embodiments, notably where the cooling device 12 is passive, the cooling direction 13 may be the longitudinal axis of the motor vehicle 10.

Where the cooling system is active, the shape of the cooling circuit may vary depending on the cooling system. The cooling direction 13 may be defined as an oriented axis representing the main temperature gradient measured in the coolant fluid.

The cooling system 1 also comprises a thermal interface 11 designed to promote heat transfer from the battery 2 to the cooling device 12.

The thermal interface 11 can be made of different thermally conductive materials, including solid materials (for example pads), pasty materials (for example silicone), woolly materials, or composite materials. These different materials are characterized by their thermal conductivity, i.e. the amount of heat that can be transferred through the material in a given time.

The thermal interface 11 can be kept under pressure between the cooling device 12 and the battery 2, notably to expel any air bubbles that could hinder thermal conduction between these two elements.

The thermal interface can be of variable thickness in one or more directions. Preferably, the thermal interface is of constant thickness.

The thermal interface 11 has:
a first surface 111 in contact with the cooling device 12, and
a second surface 112, referred to as the thermal exchange surface, that is opposite the first surface 111 and intended to come into contact with or be near to the battery 2.

The transverse dimension of the thermal-exchange surface 112 in a secondary direction 14, perpendicular to the cooling direction 13 of the cooling system, increases in the cooling direction 13. This architecture notably compensates for the increase in the temperature of the coolant fluid by increasing the exchange surface, which helps to make the heat exchange more uniform, which in turn makes the temperature of the battery more uniform.

The transverse dimension of the thermal-exchange surface in the cooling direction may be increased as a function of different criteria.

According to a first criterion corresponding to a strict increase, the transverse dimension of the thermal-exchange surface increases strictly in the cooling direction 13. In other words, regardless of the measurement point A of a first transverse dimension of the thermal-exchange surface and regardless of the measurement point B of a second transverse dimension of the thermal-exchange surface, the first dimension is strictly greater than the second dimension if, and only if, point A is strictly downstream of point B in the cooling direction.

According to a second criterion corresponding to an averaged increase, the transverse dimension of the thermal-exchange surface increases overall in the cooling direction.

For example, in one embodiment of the thermal interface according to the invention, certain decreasing segments of the thermal-exchange surface may have a local decrease in the transverse dimension of the thermal-exchange surface in the cooling direction.

The decreasing segments represent a limited proportion of the thermal-exchange surface. One limitation may relate to the ratio of the surface area of the decreasing segments to the total surface area of the thermal interface. For example, the ratio between the surface area of the decreasing segments and the total surface area of the thermal interface can be less than 20%, 10%, or 5%.

Alternatively or additionally, a limitation may relate to the cumulative size of these segments according to their projection in the cooling direction. For example, the sum of the lengths of the decreasing segments is less than a percentage of the total length of the thermal-exchange surface in the cooling direction, said decreasing-segment lengths being measured in the cooling direction. This percentage can be set at a maximum of 20%, 10%, or 5%.

Various embodiments of a thermal-exchange surface 112 in a cooling system 1 according to the invention are described below with reference to FIGS. 3 to 5.

In these different embodiments, the cooling system 1 is in contact with or near to a battery 2 comprising a set of identical battery modules 21. These modules are uniformly distributed in a secondary direction 14, perpendicular to the cooling direction 13 of the cooling system.

Each of these modules has a longitudinal axis in the cooling direction 13. The system further comprises a set of identical battery cells 22 arranged perpendicular to the longitudinal axis of the module 21 and uniformly distributed along this longitudinal axis. In other words, the battery cells are arranged perpendicular to the cooling direction and uniformly distributed along this cooling axis.

In each of the embodiments shown, the thermal-exchange surface 112 comprises at least one unitary surface 113 per battery module. The term “unitary surface” refers to each one-piece element of the thermal-exchange surface 112, i.e. each subassembly of the thermal-exchange surface 112 having a continuous thermal-exchange surface.

In each of the embodiments shown, all of the unitary surfaces are identical, regardless of the battery module with which the unitary surface is associated. In alternative embodiments not described, the unitary surfaces can vary depending on the module with which the unitary surface is associated and/or within a group of unitary surfaces associated with the same module.

In FIGS. 3 to 5, only one module 21 of the battery 2 is shown. The battery 2 can nevertheless contain one or more modules, for example 20 modules.

A first embodiment of a thermal-exchange interface 11 according to the invention is described in FIG. 3.

In this embodiment, for each module 21 of the battery, a single unitary surface 113 is placed in contact with the cells 22 of the module. The unitary surface 113 is substantially in the shape of a funnel oriented in the cooling direction, with the narrowest portion of the funnel being in the upstream portion of the flow direction of the coolant fluid. Preferably, the contour of the funnel shape is defined by a mathematical law 1/X. Alternatively, the contour of the unitary surface 113 may take any other form.

Thus, the contact area between a cell 22 of a battery module and the unitary surface 113 associated with the module varies as a function of the position of the cell along the longitudinal axis of the module. Notably, the contact area increases in the cooling direction. In other words, the closer a battery cell is to the inlet of the coolant fluid, the smaller the contact area of the battery cell with the thermal interface will be. Conversely, the closer a cell is to the outlet of the coolant fluid, the larger the contact area of the cell with the thermal interface will be.

In other words, within a given module, the contact area between a first cell and the unitary surface 113 is smaller than the contact area between a second cell, located further downstream than the first cell, and the unitary surface 113.

In this embodiment, when considering the battery and cooling system as a whole, the thermal-exchange surface 112 consists of a set of funnel-shaped unitary surfaces 113 that are identical to each other, each unitary surface being associated with a module of the battery 2.

The thermal resistance of the thermal interface 11 is determined by the following formula:

Rₜₕ(x)=Eᵢₜ/[Cₜₕ*S(x)]

where:
Eᵢₜ is the thickness of the thermal interface 11, assumed to be constant in this embodiment,
Cₜₕ is the thermal conductivity of the material constituting the thermal interface; Cₜₕ is constant,
S(x) is the contact area between the thermal interface and the at least one battery cell located at a distance x on an axis drawn in the cooling direction.

Given the shape of the thermal-exchange surface 112 previously defined, S(x) is an increasing function of x. The thermal interface 11 therefore has a thermal resistance Rₜₕ that decreases in the cooling direction.

The reduction of the thermal resistance Rₜₕ in the cooling direction improves the uniformity of the thermal exchanges between the battery 2 and the cooling system 1. Indeed, the increase of the temperature of the coolant fluid in the cooling direction is advantageously compensated by the decrease in the thermal resistance in this same direction.

As the thermal exchanges are more uniform in the cooling direction, the temperature of the cells of the battery is more uniform throughout the battery, especially in the cooling direction.

FIG. 6 illustrates the effect of implementing the invention according to the first embodiment.

A comparison is made between:
on the one hand, a first battery fitted with a cooling system comprising a thermal interface 11 according to the first embodiment of the invention,
on the other hand, a second battery identical to the first battery, fitted with a cooling system comprising a thermal interface that has a uniform contact area with the battery cells, and in particular the contact area between the thermal interface and the battery cells S(x) is constant in the cooling direction.

The first battery is fitted to a first vehicle and the second battery is fitted to a second vehicle identical to the first vehicle. The measurements described below are made under similar usage conditions for two vehicles.

The temporal evolution of the minimum and maximum temperatures of the cells of the first battery in the first vehicle and the second battery in the second vehicle are compared:
the y-axis 150 represents the temperature in degrees Celsius,
the curve 101 represents the evolution of the maximum temperatures of the battery cells without implementation of the invention (the measurements are taken on the second battery),
the curve 102 represents the evolution of the maximum temperatures of the battery cells with implementation of the invention (the measurements are taken on the first battery),
the curve 103 represents the evolution of the minimum temperatures of the battery cells without implementation of the invention (the measurements are taken on the second battery),
the curve 104 represents the evolution of the minimum temperatures of the battery cells with implementation of the invention (the measurements are taken on the first battery).

FIG. 6 shows that the curves 102 and 104, representing the temporal evolution of the maximum and minimum temperatures of the cells of the first battery, are very close to each other and lie between the curves 101 and 103, representing the same data measured on the second battery.

In other words,
the temperature differences between the cells of the first battery (incorporating the invention) are significantly smaller than the temperature differences between the cells of the second battery,
the maximum temperature measured in the cells of the first battery is significantly lower than the maximum temperature measured in the cells of the second battery,
the minimum temperature measured in the cells of the first battery is significantly higher than the minimum temperature measured in the cells of the second battery.

This demonstrates that implementation of the invention helps to make the temperature of the cells of a battery more uniform.

Alternative embodiments of a thermal-exchange interface 112 are shown in FIGS. 4 and 5. Only one module 21 of the battery 2 is shown. The battery 2 can nonetheless contain one or more modules.

In these embodiments, several unitary surfaces 113 are associated with each battery module 21: FIG. 4 shows a battery module associated with two unitary surfaces 113, and FIG. 5 shows a battery module associated with three unitary surfaces 113. In both of these embodiments, the unitary surfaces 113 are substantially in the shape of a funnel oriented in the cooling direction, with the narrowest portion of the funnel being in the upstream portion of the flow direction of the coolant fluid. Preferably, the contour of the funnel shape is defined by a mathematical law 1/X. Alternatively, the contour of the unitary surfaces 113 may have an entirely different shape, which may optionally vary from one unitary surface to another.

The unitary surfaces 113 are uniformly distributed in the secondary direction 14, perpendicular to the cooling direction 13 of the cooling system.

Thus, in the embodiment shown in FIG. 4, two unitary surfaces 113 are in contact with each of the cells in the battery module. Similarly, in the embodiment shown in FIG. 5, three unitary surfaces 113 are in contact with each of the cells in the battery module.

Depending on the size of the battery cells, the embodiments associating several unitary surfaces 113 with each module can make the temperature of the cells more uniform in the secondary direction 14. In other words, since each battery cell is in contact with several unitary surfaces, this embodiment helps to limit the temperature differences within a single cell between the zones of the cell that are in contact with the thermal interface and the zones of the cell that are not in contact with the thermal interface.

The embodiments presented relate to battery cooling systems for electric or hybrid vehicles having generally simple geometry. More generally, the invention can be applied to any thermal management system having a thermal interface 11 intended to be in contact with or close to a user system 2. The invention involves defining a thermal-exchange surface 112 that makes the action of the thermal management system 1 on the user system 2 more uniform.

Depending on the geometry of the user system 2, complex calculations may be required to define the thermal-exchange surface 112 between the thermal interface 11 and the user system 2. For example, the shape of the thermal-exchange surface 112 can be calculated using simulation tools, notably three-dimensional simulation tools.

Furthermore, the definition of the shape of the thermal interface 11, and notably of the thermal-exchange surface 112, may take into account the physical properties of the material constituting the thermal interface 11, in particular the viscosity and thermal conductivity thereof.

The definition of the shape of the thermal interface may also take into account the technical capabilities and limitations of the tools used to deposit the thermal interface between the user system 2 and the thermal management system 1.

The invention provides numerous advantages. The purpose of the invention is firstly to make the action of the thermal management system on the user system more uniform, thereby facilitating control of the temperature of the user system. Among other things, better temperature control can extend the service life of the components of the user system, for example the service life of the cells in a battery. Better temperature control also optimizes the performance of the user system. For example, in the case of batteries, better control of the battery temperature allows the battery to be used within the optimal thermal operating range thereof.

Furthermore, the invention optimizes the amount of material used to make the thermal interface 11. Advantageously, the invention helps to reduce the quantity of material used, thereby reducing manufacturing cost and the mass of the thermal management system.

Furthermore, the invention helps to reduce the flow rate of the fluid used by the thermal management system (notably the coolant fluid). For example, a conventional way of making the temperature of a battery more uniform is to increase the flow rate of the coolant fluid in order to increase the heat output of the cooling system. However, the thermal interface 11 according to the invention makes it possible to modulate the thermal exchanges as a function of the temperature gradient of the coolant liquid. This solution therefore helps to make the temperature of the user system more uniform without increasing the flow rate of the coolant fluid. The invention thus helps to reduce the size of components such as the pump generating the flow of the coolant fluid.

1-9. (canceled)

10. A cooling system for a battery in an electric or hybrid vehicle, said cooling system comprising:
a cooling device and a thermal interface, wherein
the cooling device generates a movement of a coolant fluid between an inlet point and an outlet point in a cooling direction,
the thermal interface has a first surface that is at least substantially in contact with the cooling device and a second surface, the second surface being a thermal exchange surface, opposite the first surface, that is configured to come into contact with or to be close to a battery, and
the dimension of said thermal-exchange surface in a secondary direction, perpendicular to the cooling direction of the cooling system, increases in the cooling direction.

11. The cooling system as claimed in claim 10, wherein an orthogonal projection of the thermal-exchange surface onto a plane parallel to the first surface is substantially in a shape of a funnel oriented along an axis parallel to the cooling direction.

12. The cooling system as claimed in claim 11, wherein a contour of said funnel shape is defined by a mathematical law 1/X.

13. The cooling system as claimed in claim 10, wherein the thermal interface has a constant thickness.

14. An electrical power supply system for an electric or hybrid vehicle, comprising:
a battery and the cooling system as claimed in claim 10,
wherein the battery is in contact with or close to the thermal interface of the cooling system.

15. The electrical power supply system as claimed in claim 14, wherein:
the battery comprises several identical modules distributed in the secondary direction, and
the thermal-exchange surface of the cooling system comprises a set of unitary surfaces having a longitudinal axis parallel to the cooling direction, at least one unitary surface being arranged between each module and the cooling device.

16. The electrical power supply system as claimed in claim 15, wherein:
each module has a longitudinal axis of symmetry parallel to the cooling direction, and comprises a set of cells arranged perpendicularly to said longitudinal axis of symmetry and distributed uniformly along said longitudinal axis of symmetry, and
within a given module, a contact area between a first cell and the at least one unitary surface is smaller than a contact area between a second cell, located further downstream than the first cell, and the at least one unitary surface.

17. The electrical power supply system as claimed in claim 15, wherein all of the unitary surfaces of the thermal interface are identical.

18. An electric or hybrid vehicle comprising the electrical power supply system as claimed in claim 14.
